(19) United States
(12) Patent Application Publication
(10) Pub. No.: US 2007/0089333 A1
(43) Pub. Date: Apr. 26, 2007

(54) Apparatus for identifying beverage container

(76) Inventor: Barbara L. Cage, Glendale, AZ (US)

Correspondence Address: TOD R NISSLE, PO BOX 55630, PHOENIX, AZ, 85078, US

(21) Appl. No.: 11/247,999

(22) Filed: Oct. 11, 2005

(51) Int. Cl. G09F 3/00

(52) U.S. Cl. 40/310

(57) ABSTRACT

Apparatus to identify a beverage container. The apparatus includes an elongate pliable portion. A loop formed in the elongate pliable portion is adjustable to fit different sized containers and includes an intermediate portion extending from the loop to an identification member. The length of the intermediate portion is adjustable. A portion of the intermediate portion can be formed as a slip knot that moves along the pliable portion to alter the size of the loop and the length of the intermediate portion.

This invention relates to an apparatus and method for identifying beverage containers and distinguishing one from the other.

More particularly, the invention relates to an apparatus that includes a securing portion to circumscribe a beverage container and that includes an identifying member spaced apart from the securing portion such that the distance of the identifying member from the securing portion and from a surface supporting the container can be adjusted.

Apparatus for mounting identification or other information on a beverage container is well known. Placing a display tag on the neck of bottle was known at least as early as 1933 and is depicted in U.S. Pat. No. 1,971,528. Mounting an identifying device on the neck of a bottle with a clip is described in U.S. Pat. No. 2,976,629. Identification indicia mounted on an elastic clip are illustrated in U.S. Pat. No. 5,358,770. The clip is shaped to fit a liquid container. In U.S. patent application Ser. No. 11/022,640, an identification tag is attached to an elastic O-ring that fits on a container. An identification tag affixed to a ring is illustrated in U.S. patent application Ser. No. 10/166,875. The ring slides over the neck of a bottle.

The foregoing devices for identifying a container have certain disadvantages. The following discussion is made with respect to the mounting ring described in U.S. patent application Ser. No. 10/166,875, but is believed to apply in most cases to other prior art devices.

First, it usually is not practical for the ring of U.S. Ser. No. 10/166,875 to be used on beverage containers of greatly differing size. Making an elastic ring that will readily fit both a small neck on a conventional sixteen ounce plastic water bottle and around a plastic or paper cup is difficult.

Second, the identification member on the ring is connected with a clip directly to the ring with a clip. The orientation of the identification member and the ring are not be altered to facilitate distinguishing one container from another container.

Third, the ring itself can not be used to secure the identification member to the device. Instead, an auxiliary clip is necessary.

Fourth, the distance between the identification member and the ring is not adjustable to alter the “look” of the device to facilitate distinguishing one container from another.

Fifth, there appears to be no suggestion of using a second identification member that can move with respect to a first identification member to alter the “look” of the device to facilitate distinguishing one container from another.

Accordingly, it would be advantageous to provide an improved device for identifying a container and distinguishing one container from another.

Therefore, it is a principal object of the invention to provide an improved apparatus and method for identifying and distinguishing liquid containers one from the other.

These and other, further and more specific objects and advantages of the invention will be apparent to those of skill in the art from the following detailed description thereof, taken in conjunction with the drawings, in which:

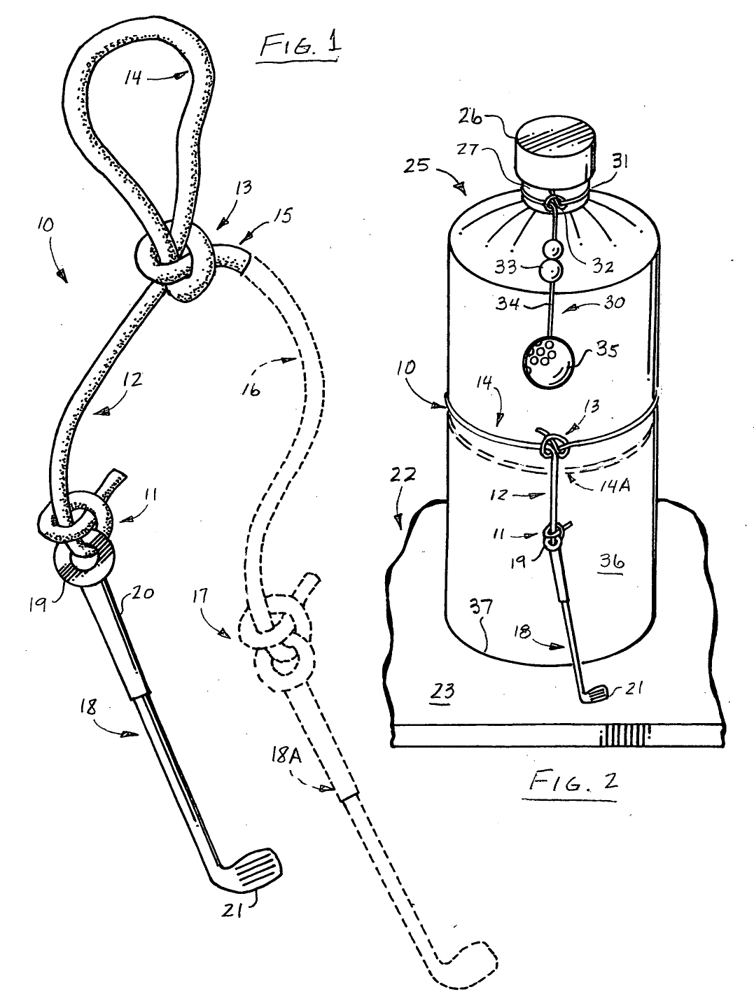

FIG. 1 is a perspective view illustrating a beverage container identification and distinguishing apparatus constructed in accordance with the invention; and,

FIG. 2 is a perspective view illustrating a beverage container with identification and distinguishing apparatus of the invention installed thereon.

Briefly, in accordance with the invention, I provide apparatus in combination with a beverage container. The apparatus functions to identify the beverage container and, in addition to or instead of such function, can function to distinguish the beverage container from other beverage containers. The apparatus comprises an elongate pliable member comprising a first end; an intermediate portion extending from the first end; and, an adjustable component slidably engaging the intermediate portion to form with the intermediate portion a loop circumferentially extending from the adjustable component about the beverage container such that the first end is spaced apart from the adjustable component, the adjustable component being slidably displaceable along said intermediate portion to adjust the size of the loop and alter the distance of the first end from the loop. The apparatus also comprises an identifying member secured to the first end.

In another embodiment of the invention, I provide an apparatus in combination with a beverage container. The apparatus identifies the beverage container and comprises an elongate pliable member. The pliable member comprises a first end and a second end; a first intermediate portion extending from the first end; an adjustable component slidably engaging the intermediate portion to form with the intermediate portion a loop circumferentially extending from the adjustable component about the beverage container such that the first end is spaced apart from the adjustable component, the adjustable component being slidably displaceable along the intermediate portion to adjust the size of the loop and alter the distance of the first end from the loop; and, a second intermediate member extending from the adjustable component to the second end. The apparatus also includes at least one identifying member secured to the first end; and, at least one other identifying member secured to the second end.

In a further embodiment of the invention, I provide apparatus in combination with a beverage container and a support surface on which the container sets. The apparatus identifies the beverage container. The apparatus comprises an elongate pliable member comprising a first end; an intermediate portion extending from the first end; an adjustable component slidably engaging the intermediate portion to form with the intermediate portion a loop circumferentially extending from the adjustable component about the beverage container such that the first end is spaced apart from the adjustable component. The adjustable component is slidably displaceable along the intermediate portion to adjust the size of the loop and alter the distance of the first end from the loop. The apparatus also includes at least one identifying member secured to the first end and resting on the support surface.

In still another embodiment of the invention, I provide an apparatus in combination with a beverage container. The apparatus identifies the beverage container and comprises an elongate pliable member comprising a first end; an intermediate portion extending from the first end; and, an adjustable component slidably engaging the intermediate portion to form with the intermediate portion a loop circumferentially extending from the adjustable component about the beverage container such that the first end is spaced apart from the adjustable component. The adjustable component is slidably displaceable along the intermediate portion to adjust the size of the loop and alter the distance of the first end from the loop. The apparatus also includes at least one identifying member secured to the first end; and, at least one other identifying member displaceable along the intermediate portion between the first end and the adjustable component.

Turning now the drawings, which depict the presently preferred embodiments of the invention for the purpose of illustration thereof, and not by way of limitation of the invention, and in which like characters refer to corresponding elements throughout the several views, FIG. 1 illustrates an apparatus constructed in accordance with the invention and comprising an elongate pliable string or cord 10. Pliable string 10 can be fabricated from cotton thread, synthetic thread, metal, plastic, or any other desired material. String 10 includes first end 11, second end 15, and intermediate portion 12 extending from first end 11. A slip knot 13 or other component adjustable along at least a portion of the length of string 10 (such as, for example, an alligator clip or a component that fits through a slot in portion 12 and can slide along the slot to alter the size of loop 14) engages the intermediate portion 12. Loop 14 is formed from a section of portion 12 such that knot 13 is spaced apart from first end 11. Sliding knot 13 along portion 12 adjusts the size of loop 14 and alters the distance between knot 13 and end 11. End 11 is connected to identifying member 18. End 11 is tied to member 18 through the opening in eyelet 19. Eyelet 19 is fixedly secured to the handle 20 of member 18. Any desired method or apparatus can be utilized to secure end 11 to an identification or distinguishing member 18.

If desired, second end 15 can be extended such that string 10 includes a second intermediate member that is shown by dashed lines 16 and that extends from knot 13 to a second identification and/or distinguishing member 18A. End 17 of member 16 is tied to member 18A. Member 18A is identical to member 18, but this need not be the case.

In use, the apparatus of FIG. 1 is secured around a beverage container 25 in the manner indicated in FIG. 2. Slip knot 13 is moved along intermediate portion 12 such that loop 14 of string 10 extends around container 25 and secures string 10 to container 25. The section of portion 12 that extends from knot 13 to eyelet 19 in FIG. 2 is long enough such that the head 21 of member 18 rests on the top support surface 23 of the table 22 on which the bottom 37 of container 25 sets. The contacting of an identification or distinguishing member 18A with a support surface 23 can function to produce an appearance that further distinguishes a beverage container 25 from other beverage containers, especially when the other beverage containers have a similar appearance or identical appearance with respect to container 25. Knot 13 can be adjusted to alter the position of loop 14 on container 25 and/or to alter the distance of member 18 from loop 14 such that member 18 contacts and is canted on surface 23 in the manner illustrated in FIG. 2, or is lying flat on surface 23 with substantially its entire length parallel to surface 23. Of course, the position of loop 14 on container 25 and/or the length of the section of portion 12 extending from knot 13 to end 11 can be adjusted such that member 18 hangs on container 25 suspended completely above support surface 23, as does identification member 35.

The position of loop 31 on container 25 and the length of the intermediate portion 34 intermediate member 35 and knot 32 is short enough to suspend identification member 35 above surface 23. Intermediate portion 34 extends from member 35 and a section of portion 34 comprises the loop 31 circumferentially extending around the neck 27 of container 25. Top 26 is removably sealingly mounted on neck 27. Slip knot 31 is connected to portion 34. Beads or other identification or distinguishing members are slidably movably mounted on portion 34 and can be moved to different positions intermediate knot 31 and member 35. Beads or other members mounted on portion 34 provide another means for identifying container 25. For example, a plurality of containers 25 may each have an identification member identical to member 35. The apparatus of FIG. 1 that is utilized on one container 25 may, however, have a different shape or color bead 33 or identification member than the apparatus of FIG. 1 that is utilized on another container, this to distinguish one container from the other. Distinguishing one container from another is useful at a social gathering or other event where two or more people at the event each have a drink bottle or other container that is identical to the bottle or container of the other individuals at the gathering.

If desired, slip knot 13 can be slightly loosened such that the size of loop 14 is increased to form a loop of the type indicated by dashed lines 14A. Loop 14A drapes and hangs on and extends around the body 36 of container 25 but still continues to engage container 25 and does not slip down and off the container on to surface 23.

The apparatus of FIG. 1 is especially practical because (1) the slip knot 13 enables the size of loop 14 to be readily adjusted to a variety of sizes ranging from small to large, (2) elongate pliable member 10 serves the multiple functions of providing the member (i.e., the loop) that extends around a container, of providing or carrying the knot or other means utilized to adjust the size of the loop, and of providing an end 11 that secures an identification/distinguishing member to a container 25, (3) the distance of an identification/distinguishing member 18 from loop 14 is adjustable, (4) multiple adjustable identification/distinguishing members 33, 18 can be utilized, and (5) an identification member can be provided in which an identification member contacts a support surface 23.

The beverage container utilized in the practice of the invention can comprise a drinking glass, drinking cup, soda pop can, water bottle, wine bottle, or any other container containing water, milk, soda pop, wine, or any other beverage that is ingested by an individual.

An identifying member 18 can have any shape and dimension and construction and color. Member 18 preferably, when placed on a beverage container 25, functions to distinguish the beverage container from other similar or identical beverage containers. Consequently, an identification member 18 placed on one container 25 typically is different in some respect from a member 18 placed on another container 25. The difference is discernable by an individual using one or more of his or her senses of sight, sound, taste, hearing and touch. For example, if the two identification members 18 are differently shaped or colored, the individual's sense of sight can distinguish one identification member 18 from the other. If the two identification members 18 each make a different sound, the individual's sense of hearing can distinguish one member 18 from the other. If one identification member 18 is smooth and the other is rough, the individual's sense of touch can distinguish one member 18 from the other. If one identification member 18 is a pretzel and the other identification member is a gum drop, the individual's sense of taste can distinguish one member 18 from the other. If desired, one or more alphanumeric characters and/or other symbols can be included on a member 18.

Having described the presently preferred embodiments and best mode of the invention in such terms as to enable those of skill in the art to understand and practice the invention, I Claim:

1. In combination with a beverage container, apparatus for identifying the beverage container, said apparatus comprising
(a) an elongate pliable member comprising
(i) a first end,
(ii) an intermediate portion extending from said first end,
(iii) an adjustable component slidably engaging said intermediate portion to form with said intermediate portion a loop circumferentially extending from said adjustable component about the beverage container such that said first end is spaced apart from said adjustable component, said adjustable component being slidably displaceable along said intermediate portion to adjust the size of said loop and alter the distance of said first end from said loop; and,
(b) an identifying member secured to said first end.

2. In combination with a beverage container, apparatus for identifying the beverage container, said apparatus comprising
(a) an elongate pliable member comprising
(i) a first end and a second end,
(ii) a first intermediate portion extending from said first end,
(iii) an adjustable component slidably engaging said intermediate portion to form with said intermediate portion a loop circumferentially extending from said adjustable component about the beverage container such that said first end is spaced apart from said adjustable component, said adjustable component being slidably displaceable along said intermediate portion to adjust the size of said loop and alter the distance of said first end from said loop, and
(iv) a second intermediate member extending from said adjustable component to said second end;
(b) at least one identifying member secured to said first end; and,
(c) at least one other identifying member secured to said second end.

3. In combination with a beverage container and a support surface on which said container sets, apparatus for identifying the beverage container, said apparatus comprising
(a) an elongate pliable member comprising
(i) a first end,
(ii) an intermediate portion extending from said first end,
(iii) an adjustable component slidably engaging said intermediate portion to form with said intermediate portion a loop circumferentially extending from said adjustable component about the beverage container such that said first end is spaced apart from said adjustable component, said adjustable component being slidably displaceable along said intermediate portion to adjust the size of said loop and alter the distance of said first end from said loop; and,
(b) at least one identifying member secured to said first end and resting on said support surface.

4. In combination with a beverage container, apparatus for identifying the beverage container, said apparatus comprising
(a) an elongate pliable member comprising
(i) a first end,
(ii) an intermediate portion extending from said first end,
(iii) an adjustable component slidably engaging said intermediate portion to form with said intermediate portion a loop circumferentially extending from said adjustable component about the beverage container such that said first end is spaced apart from said adjustable component, said adjustable component being slidably displaceable along said intermediate portion to adjust the size of said loop and alter the distance of said first end from said loop;
(b) at least one identifying member secured to said first end; and,
(c) at least one other identifying member displaceable along said intermediate portion between said first end and said adjustable component.

5. The combination of claim 1 including a second identification member.

6. The combination of claim 1 wherein said identification member is displaceable along said intermediate portion.

7. The combination of claim 1 wherein said identification member contacts and rests on a contact surface on which said container is resting.

8. The combination of claim 5 wherein said second identification member is attached to a second intermediate portion.
